(19) United States
(12) Patent Application Publication
(10) Pub. No.: US 2023/0313693 A1
(43) Pub. Date: Oct. 5, 2023

(54) GAS TURBINE ENGINE ROTATION UNIT CONSTITUENT MEMBER AND METHOD FOR PRODUCING SAME

(71) Applicant: KAWASAKI JUKOGYO KABUSHIKI KAISHA, Kobe-shi (JP)

(72) Inventors: Yoshikatsu SATO, Kobe-shi (JP); Ryo MORIHASHI, Kobe-shi (JP); Toshiro TSUJI, Kobe-shi (JP); Hiroshi TAKI, Kobe-shi (JP); Kazushige FUJIMITSU, Kobe-shi (JP)

(73) Assignee: KAWASAKI JUKOGYO KABUSHIKI KAISHA, Kobe-shi (JP)

(21) Appl. No.: 18/199,165

(22) Filed: May 18, 2023

Related U.S. Application Data
(63) Continuation of application No. PCT/JP2021/041977, filed on Nov. 15, 2021.

(30) Foreign Application Priority Data
Nov. 20, 2020 (JP) 2020-193415

(51) Int. Cl. F01D 5/28; B23K 26/342

(52) U.S. Cl. CPC F01D 5/288; B23K 26/342; F05D 2240/307; F05D 2230/31; F05D 2230/90; F05D 2300/611; B23K 2101/001

(57) ABSTRACT

A rotor assembly component which is a component of a gas turbine engine is provided with a rotor assembly component body made from a metal, and a hard particle layer including a mass of hard particles and a matrix material, with the hard particles being made from a material harder than a material forming the rotor assembly component body. The matrix material is made solely from the material forming the rotor assembly component body. The hard particle layer is supported directly on a surface of the rotor assembly component body.

### CROSS REFERENCE TO THE RELATED APPLICATION

This application is a continuation application, under 35 U.S.C. § 111(a) of international patent application No. PCT/JP2021/041977, filed Nov. 15, 2021, which claims priority to Japanese patent application No. 2020-193415, filed Nov. 20, 2020, the entire disclosures of all of which are herein incorporated by reference as a part of this application.

### BACKGROUND OF THE INVENTION

### Field of the Invention

The present invention relates to a member for constituting a rotor assembly for a gas turbine engine, and a method for manufacturing the same.

### Description of Related Art

A member that constitutes a rotor assembly (i.e., a rotor assembly component) of a gas turbine engine, such as e.g., a turbine blade, is positioned so as to form a minute clearance relative to a shroud which is disposed radially outwards thereof and serves as a stationary member. Nevertheless, being typically made of a metal, a turbine blade may experience thermal expansion when exposed to a high-temperature gas. To ensure that the clearance from the shroud still keeps an appropriate gap distance under such a circumstance, the tip end segment of the rotor assembly component needs to be furnished with the ability to abrade (i.e., abradability) an opposing member when it and the opposing member contact with each other.

Coating of a tip endwall surface of a rotor assembly component with hard particles is proposed in the art in order to improve the abradability of that tip end segment (see, for example, Patent Document 1). Directed energy deposition (DED) such as laser cladding can be contemplated as a method to coat a tip endwall surface of a rotor assembly component with hard particles. Laser cladding enables a very fine control of the treating site and is thus advantageous as a treatment on even the narrow area of the tip endwall surface of a rotor assembly component that constitutes a gas turbine can be performed with precision. To form a cladding layer containing hard particles by means of laser cladding, a powder of the hard particles is typically delivered in the form of a jet stream onto a target site on the rotor assembly component towards which laser beam is being irradiated, together with a powder of a metal material that forms a matrix for retaining the hard particles.

### [Related Document]

### [Patent Document]

[Patent Document 1] WO 2004/052555

### SUMMARY OF THE INVENTION

However, in such a process to form a cladding from a combination of a hard particle powder and a matrix material powder, it is difficult to distribute the hard particles in a targeted fashion, exclusively on the surface of the matrix. As a result, many of the hard particles end up being distributed within the matrix without providing any contribution to abradability. In addition, the abovementioned process requires equipment to feed multiple types of powders, and also necessitates complex control to be performed with respect to the ratio of their feeding rates, timings, etc. As such, it faces a difficulty in making a satisfactory improvement on the abradability of the tip end of a rotor assembly component and also leads to waste in cost.

An object of the present invention is to improve the abradability of a rotor assembly component for a gas turbine engine in a simple way and at a low cost to overcome the abovementioned problem.

To achieve the foregoing object(s), the present invention concerns a rotor assembly component which is a component that constitutes a rotor assembly of a gas turbine engine, and the component includes: a rotor assembly component body made from a metal; and a hard particle layer including a mass of hard particles made from a material harder than a material forming the rotor assembly component body and a matrix material retaining the hard particles and made solely from the material forming the rotor assembly component body, with the hard particle layer being supported directly on a surface of the rotor assembly component body.

According to this configuration, the hard particles can be supported in an exposed manner on a surface of the rotor assembly component, thereby achieving definitely improved abradability. Further, the hard particles are used as the sole cladding material onto a surface of the rotor assembly component, thereby simplifying a treatment process. In addition, a significant reduction can be achieved of unused hard particles that do not provide any contribution to abradability improvement, thereby improving a cost efficiency.

The present invention also concerns a method for manufacturing a rotor assembly component, with the method including: constructing a rotor assembly component made from a metal; and forming a hard particle layer, the forming including irradiating directed energy beam towards a surface of the rotor assembly component body and delivering only a powder of hard particles in the form of a jet stream onto an area thereof towards which the directed energy beam is irradiated, with the hard particles being made from a material harder than a material forming the rotor assembly component body and with the hard particle layer including a mass of the hard particles and a matrix material retaining the hard particles and made solely from the material forming the rotor assembly component body.

According to this configuration, so-called directed energy deposition is relied upon, thanks to which a treatment can be accurately performed even in cases where the hard particle layer is to be formed on a narrow area like that of the tip endwall surface of a turbine blade which is one example of the aforementioned rotor assembly component.

Any combinations of at least two features disclosed in the claims and/or the specification and/or the drawings should also be construed as encompassed by the present invention. Especially, any combinations of two or more of the claims should also be construed as encompassed by the present invention.

### BRIEF DESCRIPTION OF THE DRAWINGS

The present invention will be more clearly understood from the following description of a preferred embodiment, made with reference to the accompanying drawings. However, the embodiment and the drawings are given merely for the purpose of illustration and explanation, and should not be used to delimit the scope of the present invention, which scope is to be delimited by the appended claims. In the accompanying drawings, alike symbols denote alike or corresponding parts throughout the different figures:

FIG. 1 shows a longitudinal cross sectional view of an example gas turbine engine that includes a rotor assembly component, in accordance with an embodiment of the present invention;

FIG. 2 shows a top view of a turbine blade as a rotor assembly component, in accordance with an embodiment of the present invention;

FIG. 3 shows a schematic diagram that illustrates the rotor assembly component in a cross section along the line in FIG. 2, in accordance with an embodiment of the present invention;

FIG. 4 shows a schematic cross sectional view that illustrates the vicinity of a hard particle layer in FIG. 3 on an enlarged scale;

FIG. 5 shows a schematic cross sectional view that illustrates the vicinity of an edge of the hard particle layer in FIG. 4 on an enlarged scale;

FIG. 6 shows a schematic cross sectional view for explanation of how to calculate a percentage of embedded length in a hard particle layer on a rotor assembly component, in accordance with an embodiment of the present invention;

FIG. 7 shows a schematic top view for explanation of how to calculate the abovementioned percentage of embedded length; and

FIG. 8 shows a schematic view of an example DED apparatus, in accordance with an embodiment of the present invention.

### DESCRIPTION OF EMBODIMENTS

In the following text, an embodiment according to the present invention will be described in accordance with the drawings; however, the present invention is not limited to this embodiment.

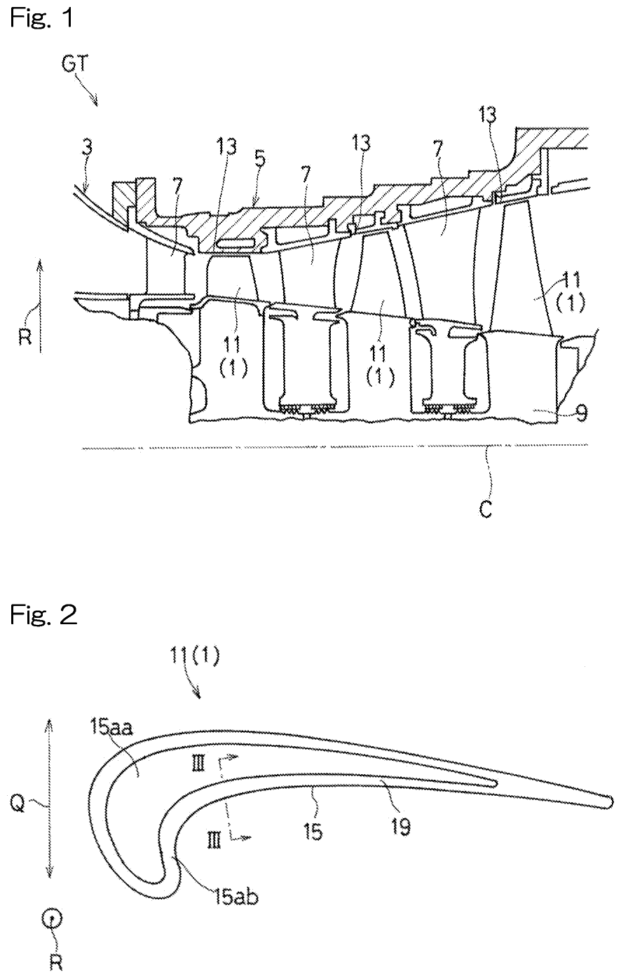

FIG. 1 depicts a gas turbine engine (which will hereinafter be referred to simply as a gas turbine) GT that includes a rotor assembly component 1, in accordance with an embodiment of the present invention. In the gas turbine GT, a turbine 5 is driven by compressing air introduced from an external environment in a compressor (not shown), guiding the same into a combustor 3 in which a fuel is combusted together with the compressed air, and feeding the resulting, high-temperature and high-pressure combustion gas into the interior of the turbine 5.

In the turbine 5, a plurality of nozzles (or vanes) 7 are disposed in an axial direction so as to alternate with and be adjacent to a plurality of turbine blades 11 disposed on the outer peripheral surface of a rotor 9 that constitutes a rotor unit of the gas turbine GT. The remainder of the discussion will mostly focus on a turbine blade 11 as an example rotor assembly component 1 for the instant embodiment. Each turbine blade 11 is covered by a shroud 13 (i.e., a portion of a casing of the turbine 5) from outside in a radial direction R. Consequently, the tip endwall surface of the turbine blade 11 in the radial direction R confront the shroud 13 in the radial direction R via a minute clearance.

Note that, in addition to a rotational member (e.g., the abovementioned turbine blade 11 or rotor 9), a stationary member (e.g., the abovementioned shroud 13) that opposes the rotational member in a radial direction is also encompassed herein within the term, rotor assembly component 1 which is, namely, a member that constitutes a rotor unit of the gas turbine engine. Examples of the rotor assembly component include, in addition to the example member mentioned above, a compressor impeller, a rotor, or a labyrinth seal.

Note that the terms “radial direction R” and “circumferential direction Q” herein denote a radial direction and a circumferential direction, respectively, with respect to the axis C of rotation of the rotor assembly component 1.

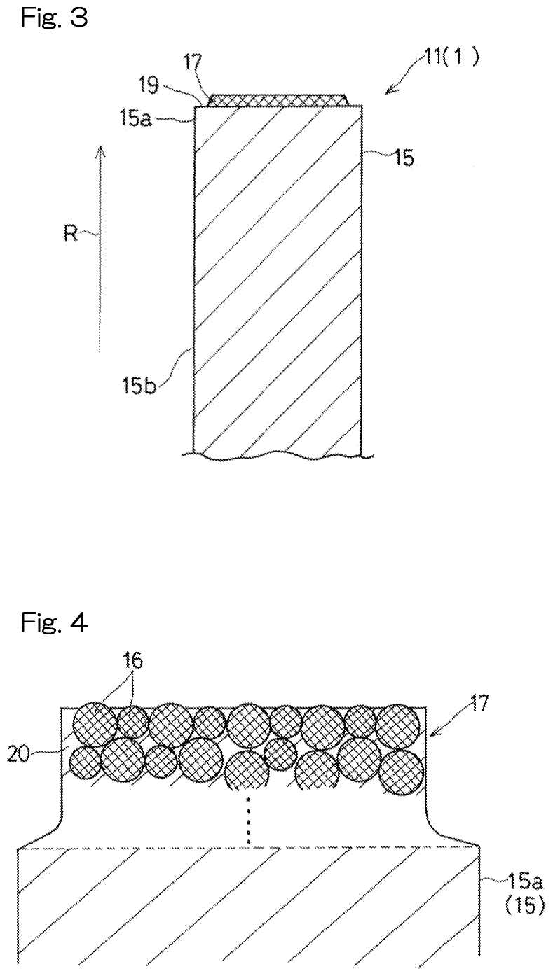

As illustrated in FIG. 2, the turbine blade 11 as a whole has a shape that is curved so as to be bulged in one of circumferential directions Q. As illustrated in FIG. 3, the turbine blade 11 serving as the rotor assembly component 1 according to the instant embodiment comprises a rotor assembly component body 15 made from a metal, and a hard particle layer 17 that includes a mass of hard particles 16 and a matrix material 20 as will be further discussed later. The hard particle layer 17 is formed on a surface 19 of the tip end segment 15a of the rotor assembly component body 15 in the radial direction R (which will hereinafter be simply called a “tip end surface.”) More specifically, the tip end segment 15a of the turbine blade 11 has an intermediate region 15aa and a region 15ab peripheral to the intermediate region 15aa, and the intermediate region 15aa is slightly recessed inwards in the radial direction R in such a way that the peripheral region 15ab is formed to slightly project outwards in the radial direction R by an amount corresponding to that recess, as can be seen in FIG. 2. The hard particle layer 17 depicted in FIG. 3 is formed on the surface 19 of the peripheral region 15ab of the tip end segment 15a.

The term “hard particles” herein denote particles made from a material harder than a material forming the rotor assembly component body 15 on which they are supported. Note that the hard particles 16 are also harder than a material forming a member to which the tip end segment 15a of the rotor assembly component 1 is to be opposed (which is, in the instant example, the shroud 13 shown in FIG. 1).

The hard particle layer 17 provided in this fashion on a surface of the rotor body component 1 results in improved abradability of the rotor body component 1. To provide a more efficient improvement of the abradability of the rotor body component 1, a percentage of a surface of the hard particle layer 17 that is occupied by the hard particles 16 is preferably, for example, at least 55%, and more preferably at least 65%. In this context, the phrase “percentage of a surface . . . occupied . . . ” represents the percentage of an area, in which the hard particles 16 are externally exposed, relative to the total surface area of the hard particle layer 17.

In the instant embodiment, the mass of hard particles 16 included in the hard particle layer 17 are composed of a single material. With such a configuration, a treatment process is simplified. Specifically, since no cladding material is employed other than that of the rotor assembly component body 15 and that of the hard particles 16 composed of a single material, no equipment to feed multiple types of powders is required during a cladding treatment, and furthermore, the need for complex control with respect to the ratio of their feeding rates, timings, etc. is also obviated. Nevertheless, the hard particle layer 17 may include more than one type of hard particles that are composed of different materials.

Further, a material different from the hard particles 16 and present in the vicinity of these hard particles 16 so as to retain them, as shown in FIG. 4, is generally referred to, herein, as a “matrix material 20.” In the instant embodiment, the matrix material 20 is made solely from the material forming the rotor assembly component body 15. Note that, in the instant embodiment, the matrix material represented by the material of the rotor assembly component body 15 is a nickel (Ni)-based, heat resistant alloy and the rotor assembly component body 15 is constructed by die casting. The material forming the hard particles is cubic boron nitride (cBN).

Note that, while more than one type of hard particles composed of different materials may be included in the hard particle layer 17, certain type(s) of particles thereamong may be incorporated therein for the purpose of retaining the other type(s) of particles, and in that case, the certain type(s) of particles do not correspond to “hard particles” and rather qualify as the “matrix material” that is defined as such herein (also note that, in such a case, the “matrix material . . . made solely from the material forming the rotor assembly component body” is not met.)

Note that the material of the rotor assembly component 1 and the material forming the hard particles 16 are not limited to the abovementioned examples. For the material of the rotor assembly component body 15, use can be made of, for example, a titanium (Ti)-based alloy, a cobalt (Co)-based alloy, or an iron (Fe)-based alloy. Also, the construction method for the rotor assembly component body 15 is not limited to die casting. For the material of the hard particles 16, use can be made of, for example, titanium carbide (TiC), silicon carbide (SiC), tungsten carbide (WC), niobium carbide (NbC), or chromium carbide (Cr₃C₂).

In more detail, the hard particle layer 17 is supported directly on the tip endwall surface 19 of the rotor assembly component body 15. The expression, “directly” supported herein means that the hard particle layer 17 is supported on the tip endwall surface 19 in contact therewith by using, as the matrix material 20 for retaining the hard particles 19, the material forming the rotor assembly component body 15, not a cladding material.

In other words, a portion of the rotor assembly component body 15 that adjoins the hard particle layer 17 and is integrated with the matrix material of the hard particle layer 17 (which is, in the instant example, the tip end segment 15a) is formed of the same material as that of the major part 15b (i.e., portions other than the tip end segment 15a) of the rotor assembly component body 15, and, in addition, the peripheral edge region 15ab (i.e., a lateral surface) of the tip end segment 15a is in a continued surface condition from the major part 15b and has a continuous shape from the major part 15b. The phrase “a continued surface condition from the major part 15b” herein implies that there is no discontinuity, such as a seam, between the tip end segment 15a and the major part 15b and they have the same glossiness and surface roughness. For instance, those embodiments where a grinding treatment has been exclusively performed on a lateral surface of the tip end segment 15a do not satisfy “a continued surface condition from the major part 15b.” Further, the phrase “a continuous shape from the major part 15b” herein implies that the surface line condition or curve condition in a cross sectional view shows smooth connection between the major part 15b and the tip end segment 15a. For instance, those embodiments where only the tip end segment 15a has a such a shape that is laterally bulged do not satisfy “a continuous shape from the major part 15b.”

Further, in the instant embodiment, the hard particle layer 17 is formed, in a top view (i.e., in a view along the radial direction R), within a region in which the tip end segment 15a of the rotor assembly component body 15 extends.

Since the rotor assembly component 1 in the instant embodiment thus employs no cladding material other than that of the rotor assembly component body 15 and that of the hard particles 16, lateral bulging of the cladding zone from the rotor assembly component body 15 can be prevented. Further, bulging of the cladding zone from the tip end side can be mitigated. In this way, the rotor assembly component 1 can be applied for use in size and dimensions that are closer to those of its design specification, guaranteeing with little effort the performance of the gas turbine GT to which it is applied.

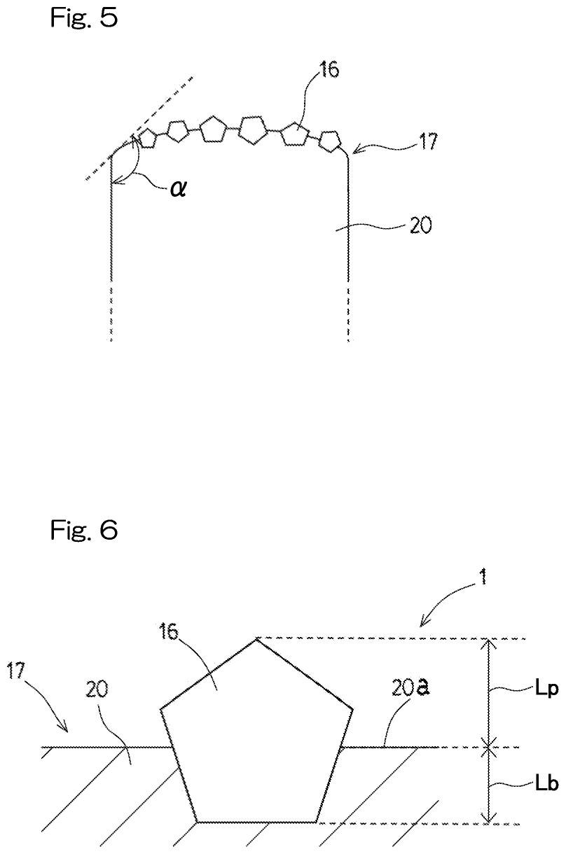

Note that, from the aerodynamic viewpoint, an edge angle α for the hard particle layer 17 shown in FIG. 5 (i.e., an angle formed between a lateral surface and a tip end surface at the forefront tip portion of the hard particle layer) is at least 90°, though an angle closer to 90° is desirable. More particularly, the edge angle α is preferably no more than 150°, for example, and more preferably no more than 135°.

In the rotor assembly component 1 according to the instant embodiment, a percentage of embedded length for the hard particles 16 ranges from at least 70% to less than 100%. The “percentage of embedded length” for the hard particles 16 herein refers to a percentage of a length thereof that is embedded in the matrix material 20 in a cross section of the hard particle layer 17. Namely, a percentage of embedded length for an individual hard particle 16 (which will hereinafter be referred to as a “percentage of embedded individual length”) is calculated by the formula: Lb/(Lp+Lb) wherein Lp and Lb represent, in a cross section of the hard particle layer 17 as shown in FIG. 6, the length of a portion of such a hard particle 16 that protrudes from the matrix material surface 20a in a direction normal to the matrix material surface 20a (which will hereinafter be referred to as a “protruding portion length”) and the length of a portion of the same hard particle that is embedded in the matrix material 20 in a direction normal to the matrix material surface (which will hereinafter be referred to as an “embedded portion length”), respectively. In the instant embodiment, a “percentage of embedded length” is defined as an average value of the percentages of embedded individual length for the hard particles 16 contained in a test piece that is sampled from the rotor assembly component 1 in the way discussed later, and this value is set to be between at least 70% and less than 100%.

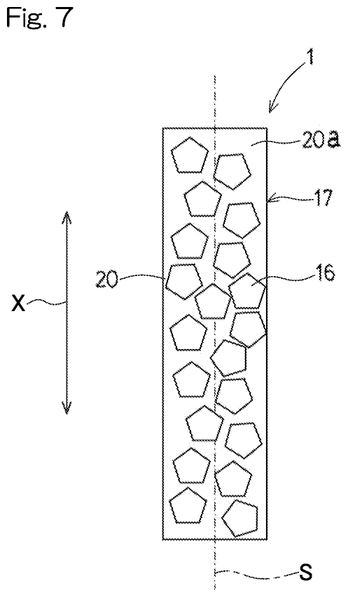

As illustrated in FIG. 7, the cross section S of the rotor assembly component 1 used for the measurement of the percentage of embedded length is a cross section that is cut along a treating direction X for the hard particle layer 17—namely, a direction in which a powder jet nozzle is displaced during a cladding treatment as will be further discussed later—and perpendicularly to the matrix material surface 20a at the midpoint of the matrix material surface 20a in a width direction thereof (i.e., a direction perpendicular to the treating direction X). Typically, the mentioned treating direction X is a longitudinal direction of the rotor assembly component 1 in a top view thereof. The percentage of embedded length is defined as an average value of the percentages of embedded individual length for all of the hard particles 16 present in such a cross section. Note, however, that a particle with an extremely small particle size as observed in the cross section S is highly likely to be, actually, a corner edge of a particle. Therefore, it is excluded from the average value calculation for the purpose of improving the accuracy of the percentage of embedded length.

By choosing the percentage of embedded length to be at least 70%, the hard particles 16 are more reliably retained by the matrix material 20, and possible detachment of the hard particles 16 upon the sliding contact of the rotor assembly component 1 with its opposing member can be mitigated. In particular, by choosing the value of the percentage of embedded length to be 70% in addition to choosing the percentage of the surface occupied to be at least 55% as discussed earlier, excellent abradability can be maintained for a prolonged period of time. It should be noted that the percentage of embedded length more preferably ranges from at least 80% to no more than 95%, and further preferably ranges from at least 85% to no more than 90%. Nevertheless, the percentage of embedded length may even be less than 70%.

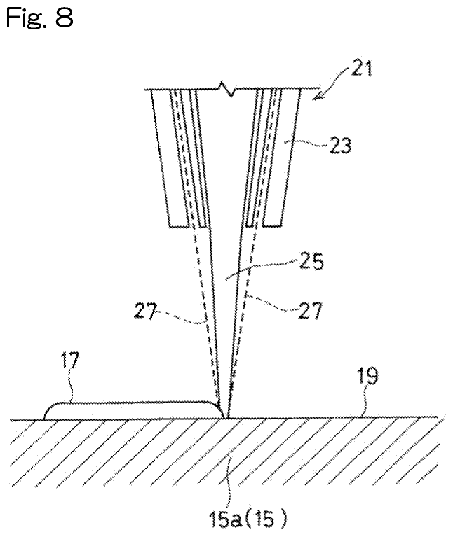

In the instant embodiment, the hard particle layer 17 is built on the tip endwall surface 19 of the rotor assembly component body 15 by directed energy deposition (which will hereinafter be expressed as “DED”). More specifically, in the instant embodiment, the treatment is performed by means of laser cladding that relies on laser beam for directed energy. As illustrated in FIG. 8, laser beam is irradiated from a nozzle 23 of a DED apparatus 21 towards the tip end segment 15a of the rotor assembly component body 15 which acts as a matrix, while a powder 27 of the hard particles is delivered in the form of a jet stream onto the area to which the laser beam 25 is irradiated.

The DED apparatus 21 used in the instant embodiment includes a centrally arranged directed energy beam (which is, in this example, laser beam) and a powder jet nozzle (i.e., the aforementioned nozzle 23) with an annular slit arranged coaxially about the directed energy beam. The powder jet nozzle may, instead, be a nozzle with a plurality of holes arranged coaxially and at uniform intervals about the directed energy beam. The use of such an apparatus can provide a simplified configuration to perform a treatment that provides a hard particle layer. Nevertheless, the specific form of implementation for the treatment by DED is not limited to the illustrated example and may be any other form of implementation commonly utilized for the treatment.

The application of DED enables a cladding treatment to be accurately performed on a narrow width range (e.g, approximately between 0.3 mm and 3 mm) like the tip endwall surface 19 of the turbine blade 11. This allows the hard particle layer 17 itself to be formed, in a top view (i.e., in a view along the radial direction R), within a region in which the tip end segment 15a of the rotor assembly component body 15 extends, as discussed earlier.

Note that, while the abovementioned DED is preferred as the method for building the hard particle layer 17 because it allows a cladding treatment to be locally and accurately performed on the tip endwall surface 19 of the turbine blade 11, any method other than DED can be used so long as a high building accuracy equivalent to or better than that of DED can be achieved therewith.

Further, in order for the abovementioned highly accurate treatment to be performed with ease, it is desirable that the particle size of the hard particles 16 be smaller than the width dimension of the treating site.

Note that the tip end segment 15a of the rotor assembly component body 15 on which the hard particle layer 17 is formed or is to be formed may be provided with a layer prepared by a surface treatment such as an anti-oxidation treatment. In this case, a surface treatment may be performed on the tip end segment 15a of the rotor assembly component body 15 before the hard particle layer 17 is formed thereon by DED, or alternatively, the hard particle layer 17 may be formed before the surface treatment is performed thereon.

Also, a damaged portion on the rotor assembly component body 15 may be repaired before the hard particle layer 17 is formed thereon.

As described thus far, in the rotor assembly component 1 and with the manufacturing method therefor according to the instant embodiment, the hard particles can be supported in an exposed manner on a surface of the tip end segment 15a of the rotor assembly component 1, thereby achieving definitely improved abradability.

In addition, a significant reduction can be achieved of unused hard particles that do not provide any contribution to abradability improvement, thereby improving a cost efficiency.

While a preferred embodiment of the present invention has thus far been described with reference to the drawings, various additions, changes, or omissions can be made therein without departing from the principle of the present invention and are thus encompassed within the scope of the present invention.

### REFERENCE SYMBOLS

1 rotor assembly component
11 turbine blade
15 rotor assembly component body
16 hard particles
17 hard particle layer
20 matrix material
21 DED apparatus
25 laser beam (directed energy beam)
GT gas turbine engine

What is claimed is:

1. A rotor assembly component for constituting a rotor assembly of a gas turbine engine, the component comprising:
a rotor assembly component body made from a metal; and
a hard particle layer including a mass of hard particles made from a material harder than a material forming the rotor assembly component body, and a matrix material retaining the hard particles and made solely from the material forming the rotor assembly component body, the hard particle layer being supported directly on a surface of the rotor assembly component body.

2. The rotor assembly component as claimed in claim 1, wherein the hard particle layer is formed by a powder of the hard particles delivered in the form of a jet stream onto an area of a surface of the rotor assembly component body towards which directed energy beam is irradiated.

3. The rotor assembly component as claimed in claim 1, wherein the hard particles included in the hard particle layer are solely composed of a single material.

4. The rotor assembly component as claimed in claim 1, wherein, of the rotor assembly component body, a portion adjoining the hard particle layer and another portion different therefrom are in a continued surface condition and have a continuous shape.

5. The rotor assembly component as claimed in claim 1, wherein the hard particle layer is formed, in a radial view, within a region in which a portion of the rotor assembly component body that adjoins the hard particle layer extends.

6. The rotor assembly component as claimed in claim 1, wherein the rotor assembly component comprises a turbine blade.

7. The rotor assembly component as claimed in claim 1, wherein a percentage of embedded length for the hard particles, which represents a percentage of a length thereof that is embedded in the matrix material in a cross section of the hard particle layer, ranges from at least 70% to less than 100%.

8. The rotor assembly component as claimed in claim 1, wherein a percentage of a surface of the hard particle layer that is occupied by the hard particles is at least 55%.

9. A method for manufacturing a component that constitutes a rotor assembly of a gas turbine engine, the method comprising:
constructing a rotor assembly component made from a metal; and
forming a hard particle layer, the forming including irradiating of directed energy beam towards a surface of the rotor assembly component body and delivering only a powder of hard particles in the form of a jet stream onto an area thereof towards which the directed energy beam is irradiated, the hard particles being made from a material harder than a material forming the rotor assembly component body, the hard particle layer including a mass of the hard particles and a matrix material retaining the hard particles and made solely from the material forming the rotor assembly component body.

10. The method for manufacturing the rotor assembly component as claimed in claim 9, wherein the irradiating of the directed energy beam and the delivering of the hard particles in the form of a jet stream are performed by means of a directed energy deposition treatment apparatus including a centrally arranged, directed energy beam and a powder jet nozzle with an annular slit or a plurality of holes, the slit or holes being arranged coaxially about the directed energy beam.
